(19) United States
(12) Patent Application Publication
(10) Pub. No.: US 2018/0079471 A1
(43) Pub. Date: Mar. 22, 2018

(54) WATER-FILLABLE CABLE FAIRING AND METHOD

(71) Applicant: CGG SERVICES SAS, Massy Cedex (FR)

(72) Inventors: Raphael MACQUIN, Montrouge (FR); Hervé RICHER DE FORGES, Versailles (FR)

(21) Appl. No.: 15/542,168

(22) PCT Filed: Dec. 9, 2015
(86) PCT No.: PCT/IB2015/002590

§ 371 Date: Jul. 7, 2017

Related U.S. Application Data
(60) Provisional application No. 62/110,748, filed on Feb. 2, 2015.

(51) Int. Cl. B63B 21/66; G01V 1/38

(52) U.S. Cl. CPC B63B 21/663; G01V 1/3826

(57) ABSTRACT

A water-fillable fairing configured to be mounted on a cable has a fairing body and an inlet. The fairing body is at least partially made of a flexible material, and is able to hold water at a higher pressure than an average pressure outside the fairing body, while the cable is towed. The inlet, which is located on a front part of the fairing body in the towing direction, is configured to allow water to enter the fairing body when the cable is towed.

### CROSS REFERENCE TO RELATED APPLICATIONS

This application claims priority and benefit from U.S. Provisional Patent Application No. 62/110,748, filed Feb. 2, 2015, for “Fabric inflatable cross-braced fairing,” the content of which is incorporated in its entirety herein by reference.

### BACKGROUND

### Technical Field

Embodiments of the subject matter disclosed herein generally relate to mechanisms and devices for reducing drag and vibrations in cables used to tow seismic survey equipment or, more specifically, to water-fillable fairings mounted on towing cables/ropes.

### Discussion of the Background

Underground formations are explored in geophysical prospecting using waves (e.g., seismic waves and/or electromagnetic waves). The waves reflected from the formations carry information on the locations of formation's layer interfaces where the wave-propagation velocity varies, and the nature of the velocity variation. Presence of gas and oil reservoirs is estimated based on images of the underground formations generated according to this information. The surveyed underground formation may be covered by water.

Survey equipment usable in marine environments is illustrated in FIG. 1. Note that here the term “marine” is not intended to refer exclusively to sea and/or ocean, but also to lakes or other environments in which an explored formation is covered by water. A vessel 100 tows a seismic source 110 and streamer (only one labeled, 120). Deflectors 130 are employed to provide lateral forces enabling towing of streamers away from a central line C (in towing direction T for a straight line trajectory), behind vessel 100. The source and streamers may have various depth and/or lateral position control devices attached (e.g., floats, birds, etc.).

Various cables connect seismic source 110, the streamers and deflectors 130 to vessel 100, so that the towed equipment has a predetermined geometry (i.e., three-dimensional arrangement). The cables include lead-in cables 140 (only one labeled), each connecting a streamer to the vessel, wide tow ropes 150 connecting deflectors 130 to the vessel, spread ropes 160 (only one labeled) limiting distance between adjacent streamer heads, and spur lines 170 limiting distance from the leftmost and rightmost streamers to respective adjacent left and right deflectors (left and right being defined relative to towing direction T).

Cables towed at a non-zero angle relative to the towing direction generate drag due to friction with water flowing in the opposite direction from the towing direction. The drag coefficient of a cable depends on this angle, reaching a maximum when the cable is perpendicular to the flow, because the larger the angle, the larger the cable surface in the water flow. As illustrated FIG. 2, the friction between the water flow (suggested by the flow lines running from left to right) and towed cable 200 causes a pressure difference between a volume 210 ahead of the cable in the towing direction, and a volume 220 behind the cable in the towing direction. Separation between volume 210 and volume 220 may be considered plane 230 of maximum cable cross-section, perpendicular to the flow and the towing direction. This pressure difference may result in a turbulent flow 240 behind the cable, and may also make the cable vibrate, thus increasing the cable's surface perpendicular to the water flow and, thus, the drag.

The shape of the boundary surface between the cable and the water influences the drag coefficient and the manner in which the water flows around the cable. Conventionally, hairy fairings are mounted on the lead-in cables and wide-tow ropes, and solid fairings are mounted on spread ropes and spur lines to reduce overall drag and vibrations. Note that solid fairing may also be mounted on lead-in cables.

Hairy fairings are hair-like flexible strings extending from a jacket covering the cable. Hairy fairings disrupt the formation of coherent eddies in the turbulent flow behind the cable, thereby reducing the intensity of vibrations and, thus, drag due to such vibrations. Since hairy fairings are flexible, it is not necessary for them to be removed from the cables prior to spooling cables on a drum onboard the vessel. The drag coefficient may be reduced by hairy fairings to 1.2-1.5 from about 2.0, which is drag coefficient for the bare cable. Over time, hairy fairings and solid fairings on lead-in cables suffer wear and their effectiveness degrades relatively fast.

Solid fairings are made from rigid materials such as hard plastic. As illustrated in FIG. 3, solid fairings dress the cable to have a wing shape 300, resulting in a lower drag coefficient than hairy fairings (down to the 0.2-0.4 range). Although solid fairings have high efficiency when the cable is perpendicular to the water flow (i.e., towing direction), their efficiency decreases dramatically if the cable makes an angle with the water flow, yielding even a negative effect compared to bare cable. In other words, solid fairings' rigidity renders them unsuitable for providing the desired efficiency at different angles.

Additionally, a major disadvantage of solid fairings is that cables with solid fairings are not suitable for spooling with the cable on a drum (being prone to damage in such conditions). Therefore, solid fairings are removed from the cables prior to storing onboard, which increases the time and effort required to deploy and recover the cables.

Accordingly, it is desirable to develop fairings that lower drag while overcoming the above-identified drawbacks of conventional fairings.

### SUMMARY

A water-fillable cable fairing, which has a body made of flexible material that is filled with water while a cable mounted with such fairings is towed, has a drag coefficient-lowering effect similar to rigid fairings. Cables having mounted water-fillable fairings can be stored with similar ease to those having mounted hairy fairings.

According to an embodiment, there is a water-fillable cable fairing having a fairing body and an inlet. The fairing body is configured to remain mounted on a cable while the cable is towed. The fairing body is at least partially made of a flexible material, and is able to hold water at a higher pressure than pressure outside the fairing body. The inlet is located on a front part of the fairing body in a towing direction, and is configured to allow water to enter the fairing body when the cable is towed.

According to another embodiment, there is a method for reducing drag caused by a cable towed during a marine seismic survey. The method includes mounting a water-fillable cable fairing on the cable. The water-fillable cable fairing is at least partially made of a flexible material and configured to hold water at a higher pressure than an average pressure outside the fairing. The water-fillable cable fairing has an inlet configured to allow water to enter inside the water-fillable cable fairing when the cable is towed. The method further includes deploying and towing the cable with the water-fillable cable fairing mounted thereon in the water. The water-fillable cable fairing holds inside water at the higher pressure while the cable is towed.

According to yet another embodiment, there is a marine seismic survey system including seismic data acquisition equipment configured to detect waves carrying information about structure of an underground explored formation, a vessel towing the seismic data acquisition equipment, and cables connecting the seismic data acquisition equipment to the vessel. The marine seismic survey system further includes at least one water-fillable cable fairing mounted on one of the cables. The water-fillable cable fairing has a fairing body at least partially made of a flexible material, and being able to hold water at a higher pressure than an average water pressure outside the fairing body. The water-fillable cable fairing also has an inlet configured to allow water to enter the fairing body when the one of the cables is towed

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates configuration of a marine seismic survey system.

FIG. 2 illustrates a cable having a circular cross-section in water flow;

FIG. 3 illustrates a cable covered by solid fairings to have a wing shape in water flow;

FIG. 4 illustrates a water-fillable cable fairing according to an embodiment;

FIG. 5 illustrates a textile usable for the body of a water-fillable cable fairing according to an embodiment;

FIG. 6 is a water filled fairing according to another embodiment;

FIG. 7 illustrates solid fairings and water-fillable fairings in the same water flow;

FIG. 8 is a water-fillable fairing according to yet another embodiment;

FIG. 9 illustrates velocity distribution around a water-fillable fairing according to an embodiment;

FIG. 10 is a water-fillable fairing according to another embodiment;

FIG. 11 is a flowchart of a method according to an embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to cables used in marine seismic data acquisition. However, similar embodiments and methods may be used for a marine data acquisition using electromagnetic waves.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Water-fillable cable fairings according to various embodiments are as rigid and efficient in reducing drag as solid fairings, with their rigidity due to the pressurized water held therein. However, water-fillable cable fairings are also as easy to spool on a drum while mounted on the cable as hairy fairings because, once water is drained, they are light and flexible.

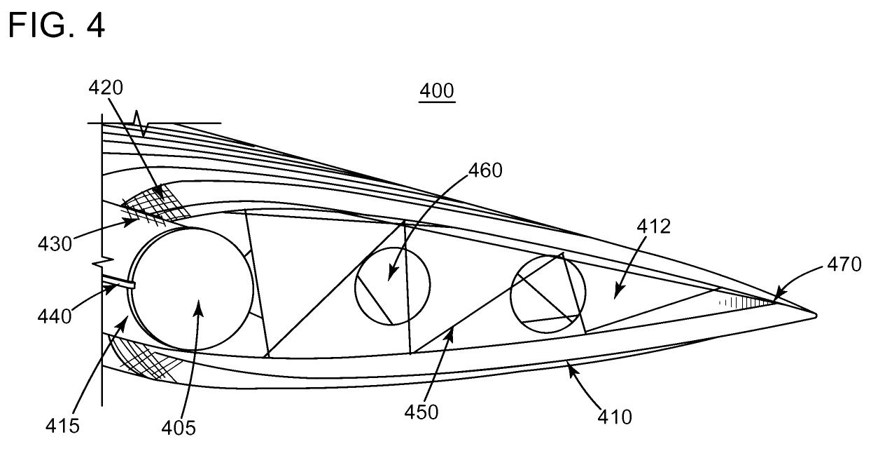

FIG. 4 is a cross-section of a water-fillable cable fairing 400 according to an embodiment. Fairing 400, which is mounted on a cable 405, has a fairing body 410 and an inlet 420 on a front part 415 of fairing body 410. Note that although only one inlet is labeled, there may be two or more inlets having similar structure and located in the front part of the fairing body.

Water enters the fairing body via the inlet until the pressure of the water inside the fairing body equals the water pressure at the inlet. Note that water pressure is the sum of static pressure depending on depth and dynamic pressure depending on water velocity. Cable's presence makes water velocity (and, thus, the dynamic pressure) to be larger in the front part than behind the fairing body. The fairing body thus holds water at a pressure higher than an average pressure outside the body.

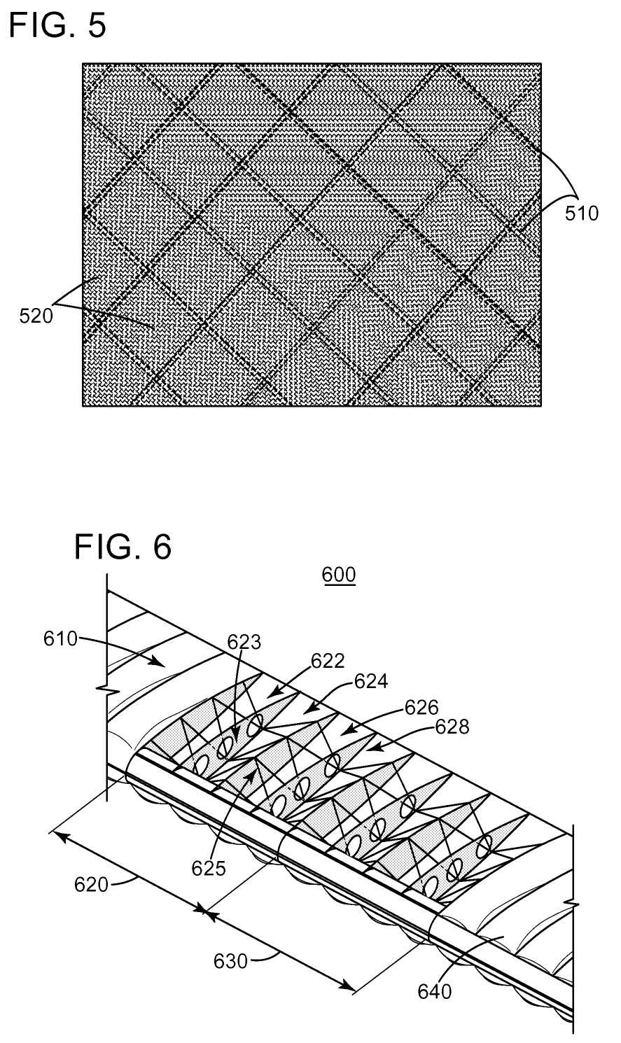

Fairing body 410 is made of a flexible material able to hold the water at a pressure higher than an average pressure outside the body. One example of such material is a zero-porosity fabric such as ripstop with a silicon coating. Ripstop (illustrated in FIG. 5) is a class of woven fabrics resistant to tearing and ripping due to reinforcing threads 510 interwoven at regular intervals (e.g., 5-8 mm) in a crosshatch pattern. Fibers 520 used to make ripstop include cotton, silk, polyester and polypropylene, with nylon content limited to the crosshatched threads 510 that make the fabric tear-resistant.

Fairing body 410 is empty before being deployed in the water as mounted on cable 405, but it is filled with water 430 entering inside the body via inlet 420 when the cable is towed through water. Inlet 420 may include a fishnet to prevent small organisms from becoming trapped inside the fairing body. The inlet may be made rigid to ensure a good opening for water to flow inside the fairing body.

The fairing body may be mounted on the cable using a closing system 440 (e.g., a zip). The fairing body may be mounted loosely around the cable to allow the water-fillable fairing to rotate around the cable. In other words, the water-fillable fairing may be rotatable.

Inside the fairing body, one or more flexible ribs 450 may be arranged to favor achieving a desired shape when the fairing is filled with water. The ribs may be made of plastic. The fairing body may be configured to have a hydrodynamic shape when holding water at higher pressure than the average pressure outside the body. The hydrodynamic shape reduces turbulence and friction with the water. For example, the shape may be similar to that of solid fairings (e.g., a wing shape).

As illustrated in FIG. 6, plural water-fillable fairings 610, 620, 630 and 640 may be mounted along a cable. Each of the water-fillable fairings may include plural divisions such as 622, 624, 626 and 628 of water-fillable fairing 620. Walls between divisions may have holes (as wall 623), or be solid (as wall 625), the holes enabling the water to circulate between adjacent divisions (e.g., between divisions 622 and 624). Returning now to FIG. 4, such a hole 460 may also be kept open by ribs.

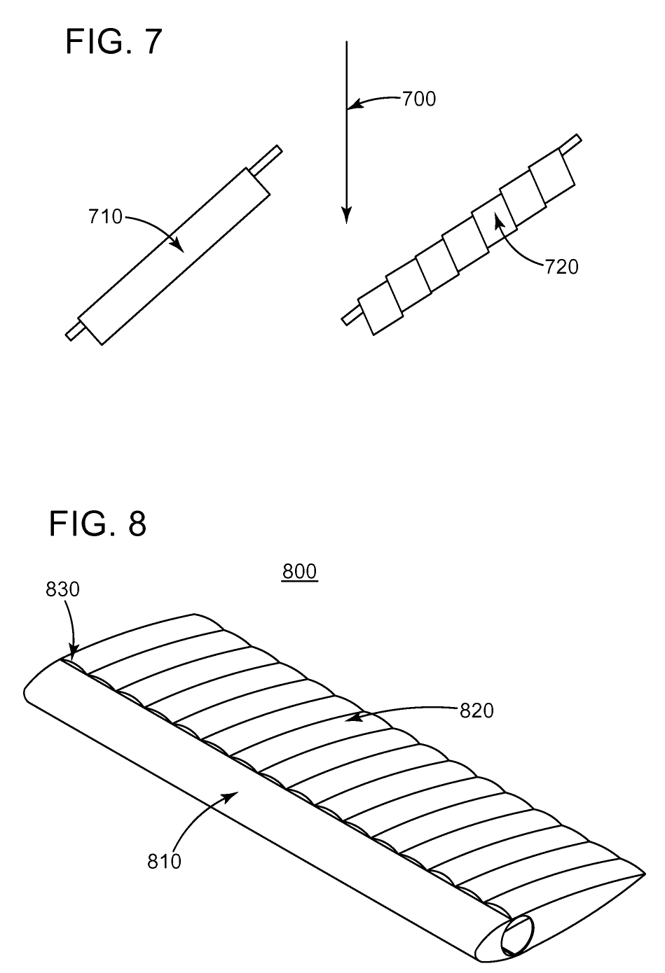

The fairing body's flexibility (as opposed to solid farings' rigidity) allows water-fillable fairings to vary their orientation and remain along the water flow. FIG. 7 illustrates solid fairings 710 and water-fillable fairings 720 in the same water flow 700. Similar to hairy fairings, water-fillable fairings maintain their efficiency in reducing drag when the angle between the cable and the water flow varies. In contrast, solid fairings keep their fixed orientation relative to the cable, which results in dramatically decreased efficiency when the cable is no longer perpendicular to the water flow angle.

In one embodiment illustrated in FIG. 8, the body of water-fillable fairing 800 includes a nose portion 810 made of a rigid material and configured to surround a front part of a cable (the front part being defined relative to towing direction T), and a soft portion 820 made of a flexible material and configured to extend behind the cable in towing direction T. One or more inlets 830 are placed between nose portion 810 and soft portion 820. The nose portion may be made of polyurethane, while the soft portion may be made of textile. The nose portion may be shaped to enhance the hydrodynamics.

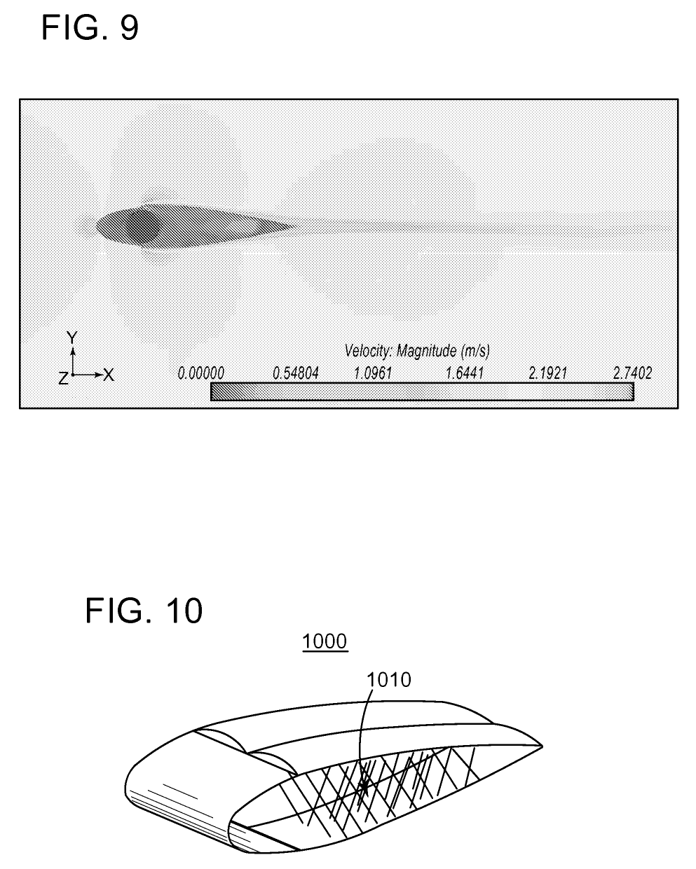

FIG. 9 is a two-dimensional graph of velocity distribution around a water-fillable fairing towed toward the left, where the higher the velocity, the darker the nuance of gray, the higher the speed.

Returning yet one more time to FIG. 4, in one embodiment, fairing body 410 may optionally include a valve 470 configured to release water when the pressure difference across the valve exceeds a predetermined threshold. Presence of such valve protects the fairing body from potential damage when pressure difference becomes too large. Alternatively, valve 470 may be a unidirectional valve configured to maintain the water inside the fairing.

FIG. 10 illustrates a water-fillable cable fairing 1000 according to another embodiment. The fairing body is at least partially made of a three-dimensional textile 1010 in which upper and lower surfaces of the fairing body are connected with threads having lengths that achieve and maintain the hydrodynamic shape of the fairing body holding the water at the higher pressure.

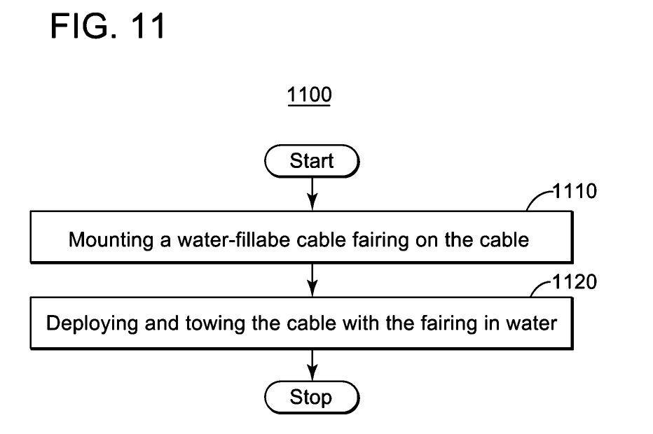

FIG. 11 is a flowchart of a method 1100 for reducing drag caused by a cable towed during a marine seismic survey. Method 1100 includes mounting a water-fillable cable fairing on the cable. The water-fillable cable fairing (e.g., 400, 600, 800, 1000, etc.) is at least partially made of a flexible material configured to hold water at a higher pressure than an average water pressure outside the body while the cable is towed. The fairing has an inlet configured to allow water to enter the water-fillable cable when the cable is towed.

Method 1100 further includes deploying and towing the cable with the fairing in the water at 1120. The water-fillable cable fairing then holds water inside itself at higher pressure than the average water pressure outside the fairing, while the cable is towed. When filled with water, the fairing may have a hydrodynamic shape to reduce drag due to the cable.

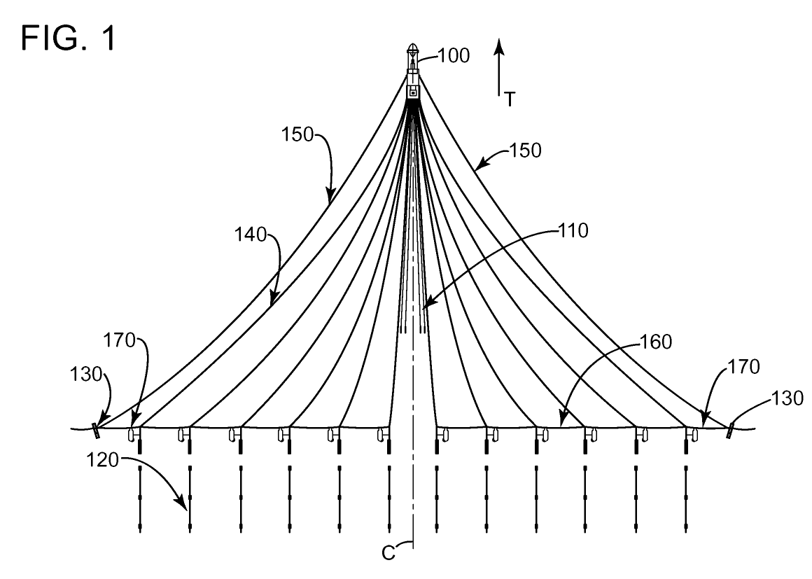

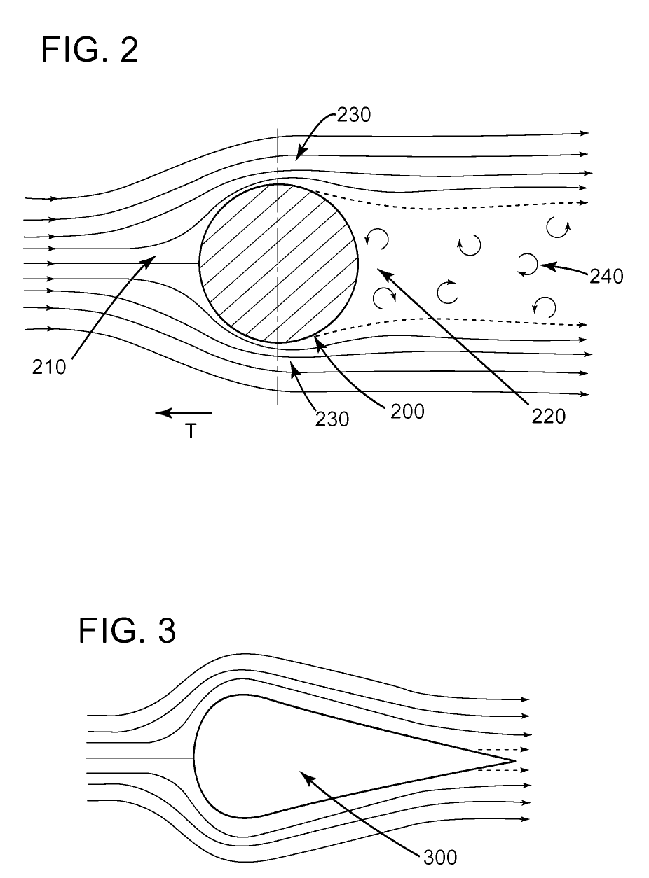

Method 1100 may further include removing water from the water-fillable cable fairing when the cable is recovered. The cable may be a lead-in cable or a wide-tow rope (that is, a cable that makes a variable non-zero angle with a towing direction in a horizontal plane). As illustrated in FIG. 1, the angle such cables make with the water flow may increase from near the vessel to near the survey equipment. Since the larger the angle the larger the drag, the water-fillable cable fairing is preferably mounted closer to the survey equipment than to the vessel.

According to one embodiment, a marine seismic survey system similar to the one illustrated in FIG. 1 has one or more water-fillable cable fairings (e.g., 400, 600, 800, 1000) mounted on the cables connecting the seismic data acquisition equipment to the vessel. Plural water-fillable cable fairings having substantially the same structure may be mounted on a lead-in rope, a wide tow rope or a separation rope. The plural water-fillable cable fairings may be mounted on different cables according to an arrangement substantially symmetric to the central line, which coincides with the towing direction when the vessel's trajectory is a straight line.

The water-fillable fairing provides plural advantages. One advantage is that the soft, flexible body enables that fairing to adapt to the water flow direction. Another advantage is that the water-fillable fairing has lower weight and volume than solid fairings while achieving a substantially similar reduction in drag. Their low weight and volume makes water-fillable fairings easy to mount and replace. Water-fillable fairings are less degraded by use than hairy fairings, and when emptied can be stored on the drums with the cables onboard the vessel. Deployment and recovery time is shorter than for solid fairings. Water-fillable fairings may also be manufactured and/or assembled onboard.

The disclosed exemplary embodiments provide water-fillable fairings usable on cables that tow seismic survey equipment and associated methods. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A water-fillable cable fairing, comprising:
a fairing body configured to remain mounted on a cable while the cable is towed, the fairing body being at least partially made of a flexible material, and being able to hold water at a higher pressure than pressure outside the fairing body; and
an inlet located on a front part of the fairing body in a towing direction, and configured to allow the water to enter the fairing body when the cable is towed.

2. The water-fillable cable fairing of claim 1, wherein the fairing body has a hydrodynamic shape when holding the water at the higher pressure.

3. The water-fillable cable fairing of claim 1, wherein the flexible material is at a reinforced textile.

4. The water-fillable cable fairing of claim 1, wherein the inlet includes a fish net configured to filter the water entering the fairing body.

5. The water-fillable cable fairing of claim 1, wherein the inlet is rigid to maintain open a pathway for water to enter the fairing body.

6. The water-fillable cable fairing of claim 1, further comprising ribs arranged inside the fairing body, the ribs being configured to favor achieving and maintaining the hydrodynamic shape of the fairing body holding the water at the higher pressure.

7. The water-fillable cable fairing of claim 1, wherein the fairing body is at least partially made of a three-dimensional textile in which an upper and a lower surface of the fairing body are connected with threads having lengths such that to achieve and maintain the hydrodynamic shape of the fairing body holding the water at the higher pressure.

8. The water-fillable cable fairing of claim 1, wherein
the fairing body includes plural divisions configured to extend substantially behind the cable in a towing direction,
the divisions are separated by walls, and
at least one of the walls has a hole enabling the water to flow between adjacent divisions.

9. The water-fillable cable fairing of claim 1, further comprising a unidirectional valve configured to maintain the water inside the fairing.

10. The water-fillable cable fairing of claim 1, wherein the fairing body has a closing system configured to enable fast mounting and removal of the fairing body on the cable.

11. The water-fillable cable fairing of claim 1, wherein the fairing body is configured to be rotatable around the cable.

12. The water-fillable cable fairing of claim 1, wherein the fairing body includes
a nose portion made of a rigid material and configured to surround a front part of the cable in a towing direction, and
a soft portion made of a flexible material and configured to extend behind the cable in the towing direction,
the inlet being placed between the nose portion and the soft portion.

13. The water-fillable cable fairing of claim 1, further comprising:
a valve configured to allow water to flow out of the fairing body, when a pressure difference across the valve exceeds a predetermined threshold.

14. A method for reducing drag caused by a cable towed during a marine seismic survey, the method comprising:
mounting a water-fillable cable fairing on the cable, the water-fillable cable fairing being at least partially made of a flexible material, and having an inlet configured to allow water to enter inside the water-fillable cable fairing when the cable is towed; and
deploying and towing the cable with the water-fillable cable fairing mounted thereon in the water, wherein the water-fillable cable fairing holds inside water at a higher pressure than an average pressure outside the fairing, while the cable is towed.

15. The method of claim 14, further comprising:
removing the water from the water-fillable cable fairing, when the cable is recovered.

16. The method of claim 14, wherein the cable on which the water-fillable fairing is mounted connects a vessel to survey equipment and makes a variable non-zero angle with a towing direction, in a horizontal plane.

17. The method of claim 14, wherein at least one other water-fillable cable fairings similar to the water-fillable cable fairing is mounted on the cable or another cable.

18. A marine seismic survey system, comprising:
seismic data acquisition equipment configured to detect waves carrying information about structure of an underground explored formation;
a vessel towing the seismic data acquisition equipment;
cables connecting the seismic data acquisition equipment to the vessel; and
at least one water-fillable cable fairing mounted on one of the cables, the water-fillable cable fairing including
a fairing body at least partially made of a flexible material, and being able to hold water at a higher pressure than an average water pressure outside the fairing body; and
an inlet configured to allow water to enter the fairing body when the one of the cables is towed.

19. The marine seismic survey system of claim 18, wherein plural water-fillable cable fairings having substantially same structure are mounted on the one of the cables.

20. The marine seismic survey system of claim 18, wherein plural water-fillable cable fairings having substantially same structure are mounted on the one of the cables and at least another one of the cables according to an arrangement substantially symmetric to a central line.
